(19) United States
(12) Patent Application Publication
(10) Pub. No.: US 2022/0129087 A1
(43) Pub. Date: Apr. 28, 2022

(54) COOKING APPLIANCE CONTROL PANEL WITH MOVEMENT DETECTOR FOR CONTROLLING COOKING ON A FUNCTION OF LOCATION

(71) Applicant: TECHNOLOGY LICENSING CORPORATION, Fort Lauderdale, FL (US)

(72) Inventors: BEN KOETHER, FORT LAUDERDALE, FL (US); EDWARD MUSIAL, MONROE, CT (US); MIKE KEEFE, BROOKFIELD, CT (US)

(21) Appl. No.: 17/508,733

(22) Filed: Oct. 22, 2021

Related U.S. Application Data
(60) Provisional application No. 63/104,970, filed on Oct. 23, 2020.

(51) Int. Cl. G06F 3/0346; A23L 5/10; A47J 36/32; A47J 37/12; H04W 4/80

(52) U.S. Cl. CPC G06F 3/0346; A23L 5/10; G01P 15/00; A47J 37/1266; H04W 4/80; A47J 36/32

(57) ABSTRACT

A cooking appliance control panel with movement detector for controlling cooking as a function of location has a microprocessor for operating an associated cooking appliance in accordance with a recipe. A movement detector determines a movement of the control panel and outputs a movement signal to the microprocessor. A communication device communicates with the microprocessor and a library of recipes The microprocessor determining when the control panel has moved more than a predetermined amount as a function of the movement signal, determines a new position of the control panel; and communicates the new position to the library to select a recipe as a function of the movement

### CROSS REFERENCE TO RELATED APPLICATION

This application claims the benefit of U.S. Provisional Application No. 63/104,970 filed on Oct. 23, 2020, the entire disclosure of which is hereby incorporated in its entirety.

### BACKGROUND OF THE INVENTION

The present invention relates to a control system for a cooking appliance, and more particularly, a control system for changing the operation of the cooking appliance to account for a change in a control panel associated with a cooking appliance determined as a function of location of the control panel.

Kitchen appliances, particularly in the commercial environment, are operated under the control of sophisticated control hardware and software. The hardware and software is contained at least in part in a control panel for the individual kitchen appliance to which it is attached. The most common example is the touch control for a microwave oven, but control panels are also provided to operate sophisticated fryers and ovens in commercial settings.

While these control panels are associated with a given recipe for operating a cooking appliance, the control panels are modular. They are self-contained, removable and interchangeable among similar, and in some cases dissimilar, types of cooking devices. To facilitate manufacture, maintenance and repair, a control panel from one model of fryer can be interchanged for a second control panel of the same fryer model type. As a result, in a commercial kitchen when there are often several fryers, ovens or the like, when a control panel malfunctions, the operator will often attempt to swap out a control panel from another cooking device as a stopgap repair measure. In some cases, operators will even change control panels between devices from different manufacturers.

However, device into which the panel is provided often is associated with a different recipe, or even a device with different features and functionality. By way of example, the operator may attempt to repair a fryer control panel programmed to cook french fries by replacing it with a chicken fryer control panel. In an even more extreme example the operator may attempt to interchange a control panel from an oven with no steaming capability to a more sophisticated oven with steam capability. This results in a cooking malfunction or inappropriate cooking of the desired food item by the cooking device. Chicken is undercooked when cooked with a french fry recipe; leading to health and other violations.

If for example in a worst-case scenario, an oven control panel is interchanged for a fryer control panel, the oven control panel is programmed to heat the heating element to a temperature as high as 500° F. Fryers operate at the lower temperatures of about 375° F. Once interchanged, a fryer operating above 375° becomes a safety hazard, as well as incapable of following the recipe. Conversely a fryer control panel placed in an oven, operates the heating element at about 375° under cooking any protein within the oven; potentially causing a health hazard let alone a failure in quality control. Or, the recipe cannot be performed at all because the fryer control panel is not programmed for steaming, and the oven into which it is inserted has steaming functionality.

Accordingly, there is a need for a control system for a cooking appliance that can account for changes in location of the control panel to change the recipe under which the cooking appliance operates to ensure conformity and safety of finished product.

### SUMMARY OF THE INVENTION

The system for controlling cooking as a function of physical location of the control panel includes a control panel having an accelerometer. The control panel includes a communication device. A library of recipes, control instructions, stores the recipes as a function of a location of the cooking appliance. The control panel communicates with the library utilizing the communication device.

During operation, if the accelerator indicates movement beyond a predetermined threshold, a microprocessor on the control panel determines a new location. The new location is broadcast to the library. The library stores cooking appliance control parameters, recipes, as a function of location of a cooking appliance and its corresponding control panel. It is determined whether the new location corresponds to a new recipe. If so, the new recipe is transmitted from the library to the control panel where the new recipe is indicated to the operator of the cooking appliance. If the change in recipe is to be accepted, then the control parameters associated with the control panel are changed.

### BRIEF DESCRIPTION OF THE DRAWINGS

The features and advantages of the present invention will become more readily apparent from the following detailed description of the invention in which like elements are labeled similarly and in which:

FIG. 1 is a schematic drawing of the system for controlling a cooking appliance in accordance with the invention;

FIG. 2 is a flowchart for the operation of the system for controlling a cooking appliance in accordance with the invention; and

FIG. 3 is a flowchart for the operation of the system for controlling a cooking appliance in accordance with a second embodiment of the invention.

### DETAILED DESCRIPTION OF THE PREFERRED EMBODIMENTS

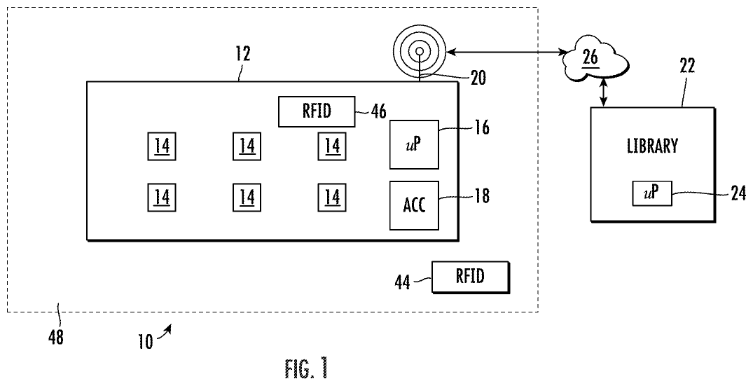

Reference is initially made to FIG. 1 in which a schematic diagram for a system 10 for controlling a cooking appliance 48 to account for change in location of the control panel in accordance with the invention is provided. System 10 includes a control panel 12 having a number of control inputs 14 which, as known in the art, may be physical or virtual buttons; each button corresponding to different control parameters for controlling the cooking appliance. For the purposes of this description one or more control parameters for operating a cooking appliance to prepare a specific food item is called a recipe.

In this embodiment, for ease of illustration, the cooking appliance is a fryer for cooking chicken. Therefore one control button 14 may correspond to the recipe, control parameters, for cooking a chicken breast, while a second button 14 may correspond to cooking wings, and a third button 14 may also correspond to wings, but the associated recipe may be extra crispy wings or even unbreaded wings; all of which correspond to a different set of control parameters; recipe.

Control panel 12 includes a microprocessor 16 which includes the control parameters, recipe, associated with each respective button 14. During initialization, microprocessor 16 is provided with a geographical location of the control panel 12, and in turn the cooking appliance to which it is associated. Cooking panel 12 is operatively coupled with a communication device 20 such as, in this embodiment, a wireless communication device illustrated by an antenna. Communication device 20 may enable wireless communication such as cellular communication, Wi-Fi communication, radio transmission, but may also be hardwired communication such as landline communications, T1 communication lines or the like, and with either type of communication type may make use of a cloud 26 to communicate with remote devices such as library 22. Library 22 may communicate with two or more control panels 12.

Control panel 12 includes an accelerometer 18 operatively coupled to microprocessor 16. Accelerometer 18 monitors movement and indicates travel direction and can be used to calculate travel distance of items with which they are associated. Therefore, accelerometer 18 is utilized to determine movement of control panel 12 relative to a known location, and output an acceleration signal when movement is detected to microprocessor 18. In other non-limiting embodiments, a global positioning system (GPS) tracker or other on board location mechanism may be used.

Control panel 12 is described as a control panel for a fryer by way of non limiting example; however the associated cooking appliance under the control of the control panel may be an oven, a proofer or the like. For example a first control panel for an oven may correspond to controlling an oven to cook roast beef, while a second control panel may correspond to an oven for baking chicken. The recipes within these types of control panels may also vary as a function of size of the oven (load), and the chicken part being baked (breasts vs. wings). Therefore exchanging one oven controller for another could result in misoperation of the oven, and the health violations resulting therefrom. The problem is exacerbated when a control panel from an oven is coupled to a fryer, or vice a versa, as discussed above.

System 10 includes a library 22 which stores recipes associated with geographical locations. As a result, the recipe for the operation of the fryer associated with one location within a restaurant or commercial cooking facility may be different than a recipe for the operation of a second fryer associated with a second or third location within the same facility, let alone in another restaurant or another facility. This recognizes the fact that in many commercial cooking facilities, the operation of the cooking appliances are grouped by function such that chicken is cooked together in one location of the facility while french fries is located in a separate location within the facility, and ovens for cooking chicken, fish or beef are in yet another location, while ovens for baking may be in yet another location. As devices at given locations are functionally changed, then new operating parameters for the location are uploaded to library 22. What is stored is a table of an identifier for a particular control panel (serial number or other identifier as known in the art), recipes for that control panel, and a location of that control panel.

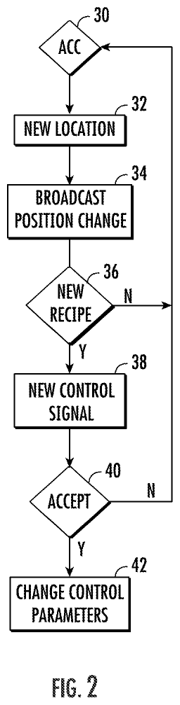

Reference is now made to FIG. 2 in which operation of system 10 is provided. Accelerometer 18 detects movement of control panel 12. When accelerometer 18 detects movement of control panel 12 accelerometer 18 broadcasts the acceleration signal to microprocessor 16; indicating the direction and distance. In a step 30, microprocessor 16 determines, whether the acceleration signal output by the accelerometer 18 exceeds a predetermined value, corresponding to movement of the control panel to a new location, or the output of accelerometer 18 is less than the predetermined value corresponding to jostling, or slight movement, i.e. not corresponding to a new location. If the output of accelerometer 18 does not correspond to a new location, then step 30 is repeated and microprocessor 16 monitors outputs of accelerometer 18.

During initialization, the physical location of control panel 12 is stored at microprocessor 16. Acceleration is a vector indicating direction and magnitude of change in speed; corresponding to a travel distance and direction. If the acceleration signal output by the accelerometer 18 exceeds a predetermined value, microprocessor 16 compares the starting location, stored in microprocessor 16 with the acceleration to determine a new physical location in a step 32. Control panel 12 broadcasts the new location to library 22 utilizing communication device 20 in a step 34.

In a step 36, microprocessor 24, located at library 22, utilizes the control panel identifier/location/recipe information stored at library 22 to determine whether the new location corresponds to a new recipe. If not, the process is returned to step 30. If a different recipe is indicated, then the control panel 12 may be disabled with a “kill” instruction from microprocessor 24, or the new recipe may be transmitted by library 22 to control panel 12 in a step 38.

It is not always necessary to change recipes as a function of change of location of control panel 12. By way of example, if the entire cooking appliance 48 associated with control panel 12 is being moved, this will be recognized as movement of control panel 12. However, if the entire cooking appliance 48 is being moved from one station/position to another, it may be desired to maintain the recipe being operated by that cooking appliance 48; no change is desired. Therefore, as a control over the operation, in a step 40 a signal is displayed at one of control panel 10 or the cooking appliance 48 to indicate that a recipe change is to be performed, and in a step 40 the “kill” signal is a disable signal which is automatically processed as a denial for recipe change, and a disablement/deactivation of control panel 12, or the operator accepts the change. If no change is desired the process returns to step 30. If the recipe change is desired, or enabled, then the control parameters are changed at microprocessor 16 for each of the associated control buttons 14 in a step 42. In this way, misoperation of the newly associated appliance is avoided.

Sometimes, both the control panel 12 and cooking appliance 48 are moved together. In other words, the control panel 12 appears to move, but is not being swapped into a different cooking appliance 48. In this instance, a false positive indicating that control panel 12 is being inserted into another device would occur in the embodiment discussed above. Therefore, in a second embodiment of the invention control panel 12 is provided with a radio frequency identification tag (RFID) 46 and cooking appliance 48 is provided with an RFID 44. Library 22 stores the identifying information in each RFID 46 mapped to its expected RFID 44 of the known corresponding cooking appliance 48.

In a preferred embodiment, each of RFID 44, 46 is a passive device, but the respective RFIDs may be active devices which periodically report. RFID 44 communicates with RFID 46, and only RFID 44 communicates with library 22.

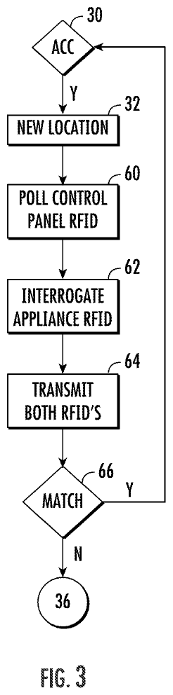

Reference is now made to FIG. 3 in which the operation of system 10 in accordance with the second embodiment of the invention is provided. The first steps are identical to the operation discussed above and like numerals are indicated to indicate like operation. In step 30, accelerometer 18 detects movement of control panel 12 and broadcast the acceleration signal to microprocessor 16, it is determined whether the detected acceleration exceeds a predetermined value corresponding to movement of the control panel or not. In step 32 the new location is determined.

Once it is determined in step 32 that a new location has been arrived at, then in a step 60, microprocessor 24 polls RFID 46 in a step 60. In response to the poll, RFID 46 polls RFID 44 of whichever appliance 48 control panel 12 now resides. In a step 64, control panel 12 transmits both the identifying information of RFID 46 and RFID 44. If control panel 12 is not disposed within any appliance 48, or is in an appliance 48 without second RFID 44, then the identifying information will be transmitted as the null set. Microprocessor 24 compares the information from RFIDs 44, 46 to determine whether the identifying information for both RFIDs 44, 46 transmitted by control panel 12 matches that stored in library 22. If there is a match then appliance 48 has been moved to an appliance operating in the same way as the previous appliance and and no further action is required and the process returns to step 30. If there is no match then control panel 12 has been removed from the expected appliance 48 and processing continues at step 36 of FIG. 2.

As is readily seen, the process of FIG. 3 happens simultaneously with the process of FIG. 2. Additionally, RFID transponders are used by way of example only, but any multifunctional detector, such as those known from Kitchen Brain's SIB™ Smart Interface Board, by way of non limiting example, having at least one function of self identifying may be used. Lastly, because the use of RFID type device is coupled with location information, asset inventorying occurs automatically.

With respect to the foregoing embodiments of the invention which have been described, it should be recognized that communications, whether between the appliance, libraries, or respective microprocessors, or any combination thereof, may be accomplished by any suitable wireless or wired means for the intended application and is a matter of design choice. Preferably, communications are effectuated through wireless communication platforms whose technology is well-established and known to those skilled in the art. More preferably, the wireless communications are performed over the cloud, using established nationwide wireless networks.

It should further be recognized that the invention is not limited to the particular embodiments described above. Accordingly, numerous modifications can be made without departing from the spirit of the invention and scope of the claims appended hereto. For example, it will also be appreciated by those skilled in the art that the invention is not limited to restaurant applications, but may be employed in any commercial, industrial food processing, institutional, or residential application wherein a cooking appliance is used. Moreover, the invention is not limited to use with any particular type of food product or appliance, and will find broad applicability in the food preparation service industry wherever the invention may be feasibly employed. Thus, the invention may be used with ovens, fryers, proofer's and the like which may be provided with microprocessor-based controller's to provide communication interface within the system in network of the invention. Accordingly, these appliances may be cloud enabled to effectuate communications with the system via the Internet.

What is claimed is:

1. A cooking appliance control panel with movement detector for controlling cooking as a function of location comprising:
a microprocessor, the microprocessor operating an associated cooking appliance in accordance with a recipe;
a movement detector for determining an amount of movement of the control panel; and
outputting a movement signal to the microprocessor;
a library of recipes, the library of recipes containing two or more recipes for operating the cooking appliance, each recipe being associated with a position of the control panel;
a communication device communicating with the microprocessor and the library of recipes;
and the microprocessor determining when the control panel has moved more than a predetermined amount as a function of the movement signal, determining a new position of the control panel; and communicating the new position to the library utilizing the communication device when the control panel has moved more than the predetermined distance.

2. The cooking appliance control panel of claim 1, wherein the microprocessor receives a changed recipe from the library when the new position corresponds to movement of more than a predetermined amount, and the microprocessor updating the recipe associated with the control panel as function of the changed recipe.

3. The cooking appliance control panel of claim 1, wherein the movement detector is an accelerometer.

4. The cooking appliance control panel of claim 1, wherein the movement is a global positioning system tracker.

5. The cooking appliance control panel of claim 1, further comprising a control panel radio frequency identification tag identifying the control panel.

6. A system for operating a cooking appliance as a function of location comprising:
a cooking appliance;
a library of recipe, the library of recipes containing two or more recipes for operating the cooking appliance, each recipe being associated with a position of the control panel,
a cooking appliance control panel removably mounted on the cooking appliance for controlling cooking by the cooking appliance as a function of location of the control panel, the cooking appliance control panel having a microprocessor, the microprocessor operating an associated cooking appliance in accordance with a recipe; a movement detector for determining a movement of the control panel; and outputting a movement signal to the microprocessor; a communication device communicating with the microprocessor and the library of recipes; and the microprocessor determining when the control panel has moved more than a predetermined amount as a function of the movement signal, determining a new position of the control panel; and
communicating the new position to the library utilizing the communication device when the control panel has moved more than the predetermined distance.

7. The system for operating a cooking appliance as a function of location of claim 6, the library comprises a microprocessor, the library transmitting a new recipe to the cooking appliance control system when the control panel has moved more than the predetermined amount.

8. The system for operating a cooking appliance as a function of location of claim 6, further comprising a first radio frequency identification tag on the control panel, storing control panel information identifying the control panel and a second radio frequency identification tag on the appliance storing appliance identifying information identifying the cooking appliance; the library storing the information control panel information and the appliance identifying information and pairings of the cooking appliance and the control panel.

9. The system for operating a cooking appliance as a function of location of claim 8, wherein the library further comprises a library microprocessor, the library microprocessor receiving and comparing the appliance identifying information and the control panel identifying information and determining whether to reprogram the control panel as a function of the comparison.

10. The system for operating a cooking appliance as a function of location of claim 8, wherein the library further comprises a library microprocessor, the library microprocessor receiving and comparing the appliance identifying information and the control panel identifying information and preventing operation of the control panel as a function of the comparison.

11. A method for controlling operation of a cooking appliance having a removeable control panel, as a function of a location of a control panel comprising the steps of:
storing recipes for operating the cooking appliance in a library, the recipes operating the cooking appliance as a function of the location of the cooking appliance determining whether the control panel has moved more than a predetermined amount relative to an original cooking appliance;
determining a new location of the control panel when the control panel has moved more than a predetermined amount relative to the original cooking appliance;
the control panel communicating with the library when the control panel has moved more than a predetermined amount corresponding to a new location relative to the original cooking appliance and retrieving a recipe from the library corresponding to the new location; and
the control panel operating a second appliance, at the new location in accordance with the retrieved recipe.

12. The method of claim 11 further comprising the steps of providing a first radio frequency ID on the appliance, the first radio frequency ID storing appliance identifying information and placing a second radio frequency ID on the control panel, the second radio frequency ID, storing control panel identifying information; the microprocessor communicating with the first radio frequency ID and the second radio frequency ID, and comparing the appliance identifying information with the control panel identifying information; the microprocessor preventing operation of the appliance by the control panel as a function of the comparison.
